(19) United States
(12) Patent Application Publication
(10) Pub. No.: US 2007/0092393 A1
(43) Pub. Date: Apr. 26, 2007

(54) Gas release port for oil-free screw compressor

(75) Inventor: William Charles Egan, Menasha, WI (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/259,385

(22) Filed: Oct. 26, 2005

(51) Int. Cl. F01C 1/16; F04C 2/00; F04C 18/00; F03C 4/00

(52) U.S. Cl. 418/201.1

(57) ABSTRACT

A gas release port and methods of fabricating such port are described herein. In an example embodiment, the gas release port is for an oil-free compressor. The compressor includes a compressor housing with a compression chamber having at least one rotor bore therein. The housing also has an inlet nozzle with the discharge port. The nozzle is configured to permit process gas to bleed out before a complete release of compressed gas. The compressor also includes at least one rotor assembly positioned within the frame. The rotor assembly includes a rotor shaft and a rotor. The rotor is positioned within the rotor bore.

### BACKGROUND OF THE INVENTION

This invention relates generally to oil-free screw compressors and more particularly, to gas release port configurations for such compressors.

Oil-free screw compressors are well known. Such compressors generally do not have a surge limit which is typical with centrifugal compressors. Therefore, such oil-free screw compressors can provide a desired process flow at a required discharge pressure even with variations in gas pressure, temperature, and composition.

At least some of such known oil-free screw compressors have large pulsation levels, high noise levels, and alternating loads with the compressor and process piping. Such pulsation levels, noise levels, and alternating loads generally are the result of a pocket passing frequency. Reducing the pulsation levels, noise levels, and alternating loads would facilitate extending the operating life of such compressors as well as improving at least some aspect of the compressor operating performance.

### BRIEF DESCRIPTION OF THE INVENTION

In one aspect, an oil-free compressor is provided. The compressor includes a compressor housing with a compression chamber having at least one rotor bore therein. The housing also has an inlet nozzle with a discharge port. The nozzle is configured to permit process gas to bleed out before a complete release of compressed gas. The compressor also includes at least one rotor assembly positioned within the frame. The rotor assembly includes a rotor shaft and a rotor. The rotor is positioned within the rotor bore.

In another aspect, a nozzle for a compressor is provided. The nozzle has a discharge port for discharging compressed gas therethrough. The nozzle is configured to permit process gas to bleed out before a complete release of the compressed gas.

In yet another aspect, a method for fabricating a nozzle for a compressor is provided. The nozzle has a discharge port for discharging compressed gas therethrough. The method includes machining openings in the nozzle that permit process gas to bleed out through the openings before a complete release of gas.

### BRIEF DESCRIPTION OF THE DRAWINGS

FIG. 1 is a perspective cut-away view of an example oil-free compressor.

FIG. 2 is a top view of a discharge port in accordance with one embodiment of the present invention.

FIG. 3 is a top view of a discharge port in accordance with another embodiment of the present invention.

FIG. 4 is a top view of a discharge port in accordance with yet another embodiment of the present invention.

### DETAILED DESCRIPTION OF THE INVENTION

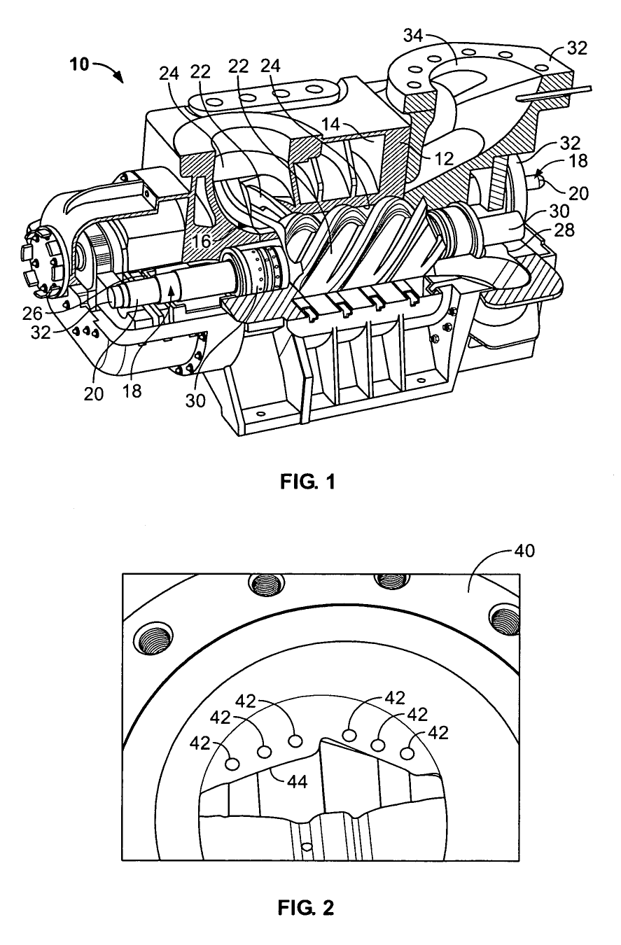

FIG. 1 is a perspective cut-away view of an example oil-free compressor 10. Although an example and specific oil-free compressor 10 is described herein, the methods and apparatus described herein are not limited to practice with any one particular oil-free compressor configuration and can be practiced in connection with many other such configurations.

Generally, compressor 10 includes a compressor frame 12, sometimes referred to herein as a housing, that includes water jackets 14 for high temperature operation and a compression chamber 16. Rotor assemblies 18 are positioned within frame 12. Each rotor assembly 18 includes a rotor shaft 20 and a rotor 22 positioned in rotor bores 24 of compression chamber 16. Each rotor assembly 18 is supported within frame 12 on bearings 26 and 28, and includes shaft seals 30 that prevent leakage of process gas from compression chamber 16. Timing gears 33 are coupled to rotor shafts 20 to synchronize rotation of rotors 22.

As shown in FIG. 1, a top inlet nozzle 32 with a top discharge port 34 is provided to discharge compressed gas for a particular application. Alternatively, a top inlet nozzle with a bottom discharge port (not shown) could be used to facilitate drainage, depending on the particular operation.

FIG. 2 is a top view of a nozzle 40 in accordance with one embodiment of the present invention. As shown in FIG. 2, nozzle 40 includes openings 42 aligned with discharge port 44 and positioned so that the center axis of each such opening 42 intersects with one of the rotor bores of the compression chamber. This arrangement provides that process gas can bleed out through openings 42 before a complete release of compressed gas. Such bleeding facilitates reduction of noise, pulsation, and alternating load levels. Openings 42 can be formed by tapping and drilling operations, and openings 42 can vary in size depending on machine size and the amount of acceptable bleeding.

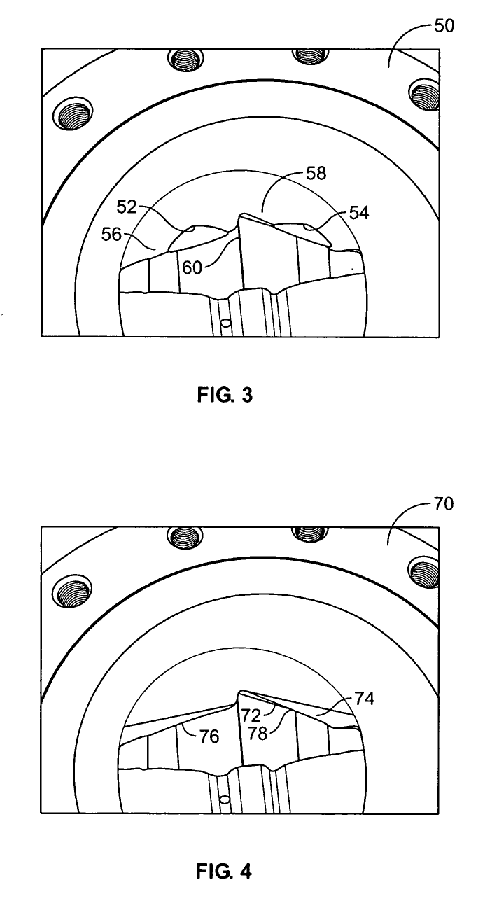

FIG. 3 is a top view of a nozzle 50 in accordance with another embodiment of the present invention. As shown in FIG. 3, nozzle 50 has scalloped openings 52 and 54 along the width of male and female lobes 56 and 58. Such scalloped openings 52 and 54 are formed, for example, by machining such openings 52 and 54 into lobes 56 and 58. Scalloped openings 52 and 54 provide that process gas can bleed out into discharge nozzle before a complete release of compressed gas through port 60. Such bleeding facilitates reduction of noise, pulsation, and alternating load levels.

FIG. 4 is a top view of a nozzle 70 in accordance with yet another embodiment of the present invention. As shown in FIG. 3, nozzle 70 has port 72 formed by a wall 74 having a selected port angle that represents an increased radial port angle as compared to the port angle shown, for example, in FIG. 2. Such increased port angle is formed by machining a contour in lobes 76 and 78. Having the increased radial port angle provides that process gas can bleed out through port 72 before a complete release of compressed gas. Such bleeding facilitates reduction of noise, pulsation, and alternating load levels.

Generally, by varying the geometry of the discharge port, process gas can bleed out into discharge nozzle before a complete release of compressed gas. Such bleeding facilitates reduction of noise, pulsation, and alternating load levels. While specific geometries are described above, other geometries are possible for reducing noise levels, pulsation levels and alternating loads within the compressor and its process piping. Therefore, alternative geometries

While the invention has been described in terms of various specific embodiments, those skilled in the art will recognize that the invention can be practiced with modification within the spirit and scope of the claims.

What is claimed is:

1. An oil-free compressor, comprising:
a compressor housing comprising a compression chamber having at least one rotor bore therein, said housing comprising an inlet nozzle comprising a discharge port, said nozzle configured to permit process gas to bleed out before a complete release of compressed gas, and
at least one rotor assembly positioned within said frame, said rotor assembly comprising a rotor shaft and a rotor, said rotor positioned within said rotor bore.

2. An oil-free compressor in accordance with claim 1 wherein said compression chamber comprises two rotor bores, and wherein said rotor assembly comprises two rotors, each said rotor positioned within one of said respective bores.

3. An oil-free compressor in accordance with claim 1 wherein said rotor assembly is supported within said frame on bearings, and wherein shaft seals facilitate preventing leakage of process gas from said compression chamber.

4. An oil-free compressor in accordance with claim 1 wherein said discharge port is positioned to discharge gas upward relative to said port.

5. An oil-free compressor in accordance with claim 1 wherein said discharge port is positioned to discharge gas downward relative to said port.

6. An oil-free compressor in accordance with claim 1 wherein said discharge port comprises openings positioned so that a center axis of each said opening intersects with said rotor bore so that process gas can bleed out through said openings.

7. An oil-free compressor in accordance with claim 1 wherein said discharge port comprises scallop-shaped openings positioned so that process gas can bleed out through said openings.

8. An oil-free compressor in accordance with claim 1 wherein said discharge port comprises an opening having a radial angle selected so that process gas can bleed out through said opening.

9. A nozzle for a compressor, said nozzle comprising a discharge port for discharging compressed gas therethrough, said nozzle configured to permit process gas to bleed out before a complete release of the compressed gas.

10. A nozzle in accordance with claim 9 wherein said discharge port comprises openings positioned so that process gas can bleed out through said openings.

11. A nozzle in accordance with claim 9 wherein said discharge port comprises scallop-shaped openings positioned so that process gas can bleed out through said openings.

12. A nozzle in accordance with claim 9 wherein said discharge port comprises an opening having a radial angle selected so that process gas can bleed out through said opening.

13. A method for fabricating a nozzle for a compressor, the nozzle comprising a discharge port for discharging compressed gas therethrough, said method comprising machining openings in the nozzle that permit process gas to bleed out through the openings before a complete release of gas.

14. A method in accordance with claim 13 wherein said machining comprising tapping and drilling openings in the nozzle.

15. A method in accordance with claim 13 wherein said machining comprises forming scallop-shaped openings positioned so that process gas can bleed out through the openings.

16. A method in accordance with claim 13 wherein said machining comprises forming an opening having a radial angle selected so that process gas can bleed out through the opening.
